(19) United States
(12) Patent Application Publication
(10) Pub. No.: US 2012/0097819 A1
(43) Pub. Date: Apr. 26, 2012

(54) HOLDER FOR A CYLINDRICAL ARTICLE

(76) Inventors: Martin John Avery, Surrey (GB); Stuart James Askew, Herefordshire (GB)

(21) Appl. No.: 13/257,711

(22) PCT Filed: Mar. 23, 2010
(86) PCT No.: PCT/GB2010/000585

§ 371 Date: Oct. 12, 2011

(30) Foreign Application Priority Data
Mar. 25, 2009 (GB) 0905148.3

(51) Int. Cl. F16M 13/00

(52) U.S. Cl. 248/346.04; 248/346.03

(57) ABSTRACT

A holder for a cylindrical article such as a gas cylinder has a base, a support member extending from the base for receiving a base of the article, and, spaced from the support member, at least one clamp device, including first and second jaw elements, extending from the base and arranged releasably to clamp the cylindrical article. The clamp device may also include springs for urging the jaw elements into an article holding position. The springs may act on bearing elements for the jaw elements.

The present invention relates to a holder for a cylindrical article, especially a holder for mounting a cylindrical article to a surface, for example a wall. The holder may in particular, but not exclusively, be for receiving a compressed gas cylinder.

It is known to mount compressed gas cylinders in an upright position against a wall, for example, in medical establishments where a cylinder of a medical gas may be mounted on a wall for ease of access. In the case of large gas cylinders, those may be arranged to stand on the floor, whilst being restrained against an immovable vertical surface, for example a wall, by means of a strap attached to an anchor device on the vertical surface.

In the case of smaller cylinders, it is frequently desirable to locate the cylinder above the floor level, in order to improve accessibility to a user and for ease of cleaning in a medical environment. It is usually important for a gas cylinder to be stored in a substantially vertical position, attached to a suitable cylinder support, with the cylinder valve uppermost.

WO2004/084981 describes a portable resuscitation system that includes a lightweight oxygen cylinder. The cylinder is held, with a number of other components, in a base unit in the form of an open-topped receptacle, which is provided with a carrying handle. The system may be wall mounted in such a way that it is readily accessible for carrying to a location of use. As attachment means to allow the base unit to be supported on an external structure there are mentioned hinging, pivoting, sliding or retractable arms, or straps attached to parts of the base unit allowing it to be strapped to the external structure. The cylinder is selectively held in place in the base unit by straps . A similar portable resuscitation system is described in WO2007/045905. The systems of WO2004/084981 and WO2007/045905 are intended for use as an entirety. Thus, the base unit, in which the oxygen cylinder is mounted, houses a number of different components of the system and is portable as a complete unit.

There is a need for a simple arrangement for mounting a cylindrical article on a support surface such as a wall.

The invention provides a holder for a cylindrical article, the holder having a base, a support member extending from the base for receiving a base of the article, and, spaced from the support member, at least one clamp device extending from the base and arranged releasably to clamp the cylindrical article.

The holder of the invention allows a cylindrical article to be releasable mounted on the base, the base facilitating correct location of the cylindrical article. In particular, when the base is so arranged that the cylindrical article is positioned vertically, the support member restrains the cylindrical article from movement in the downward direction. The clamp device can restrain the cylindrical article from undesired lateral movement during use, whilst allowing the article to be released if required, for example for replacement by a new article. The holder may be mountable on a vertical surface, for example a wall.

It is preferred that the clamp device comprises at least one resiliently deformable element. In that case, the cylindrical articles can be released by displacement of a component of the clamp device by means of resilient deformation of the resiliently deformable element, permitting removal of the article. The clamp device may, for example, comprise first and second opposed jaw elements. The first and second opposed jaw elements may be biased towards one another. In one preferred embodiment, the clamp device comprises first and second opposed jaw members, each jaw member comprising at least one jaw element. Advantageously at least one of the first and second jaw members is displaceable from a starting position, in which the jaw members co-operate circumferentially partially to enclose a cylindrical article, to a position in which the jaw elements are spaced apart by a distance at least as great as the diameter of the cylindrical article. In one embodiment, the clamp device comprises at least one resiliently deformable element for urging said jaw member towards said starting position. Preferably, the at least one deformable element comprises at least one spring. In one embodiment, the first and second jaw members are displaceable by one or more compression springs. For example, each jaw member may have a bearing element, the clamp device further including at least one spring that can act upon said bearing elements. In an especially preferred embodiment, the jaw members are mounted pivotably on parallel pivot axes such that the bearing elements of the jaw members are opposed to each other on one side of a plane containing said pivot axes and the jaw elements are opposed to each other on the opposite side of that plane. In that way, the jaw arms can be arranged in opposition and opened and closed relative to one another, whilst the bearing elements are likewise opposed to one another. Advantageously, at least one compression spring is located between the first and second bearing elements. Preferably two or more, especially three, compression springs are located between the first and second bearing elements.

It will be appreciated that, whilst in a preferred embodiment one or more compression springs are provided between the bearing elements, other spring arrangements may be possible. For example, there may be separate springs associated with each bearing element which bear on a support, instead of bearing onto the other bearing element, or other types of spring, for example tension springs, may be used with suitable adaptation of the base unit.

Preferably, one or more locating rings are provided on each bearing element to facilitate retaining of the ring in the desired position.

In one embodiment, the base comprises a vertically extending web arranged between the pivot axes of the opposed first and second jaw members.

If desired, an additional fastening device may be provided to prevent release of the cylinder. For example, a strap may be affixed to one of the jaw members and an attachment point affixed to the other jaw member for detachably receiving the strap.

Whilst the lower support member may if desired be integrally formed with the base, it is preferred for it to be releasably attachable to the base.

The base may include one or more apertures permitting affixing of the holder to a supporting structure, for example a wall.

The base may be in two parts, a first part comprising the clamp device and a second part comprising the support member. The first and second parts may be mountable separately, spaced from one another at a distance selected to be suitable for accommodating a gas cylinder. The first and second parts may, be mountable together, for example, in engagement with one another or in abutment with one another. In another embodiment, the base may comprise a common base, on which both the clamp device and the support member are provided.

In some circumstances it might be desirable for the holder to be portable. In that case, the base may be attached to a suitable support surface, for example, a planar member. By way of illustration, the holder may be mounted (as spaced parts or together) on a plate, for example a metal plate, that can be clamped to a bed or to a hospital trolley.

Certain embodiments of the invention will now be described, by way of illustration, with reference to the accompanying drawings, in which:

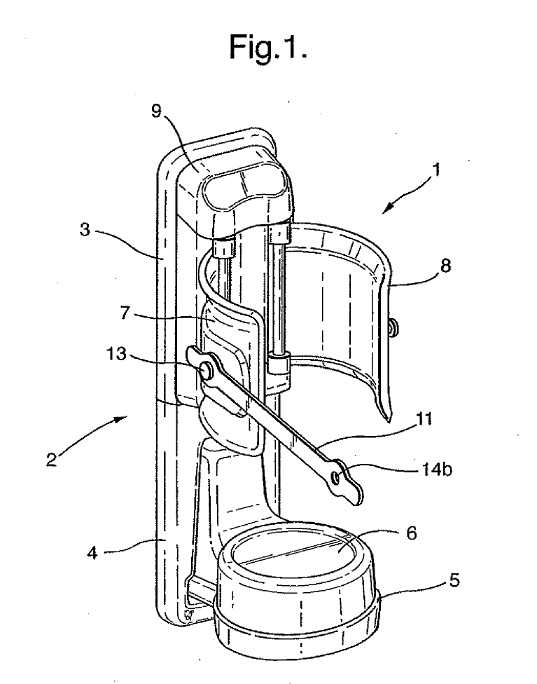

FIG. 1 is a perspective view of a first holder according to the invention;

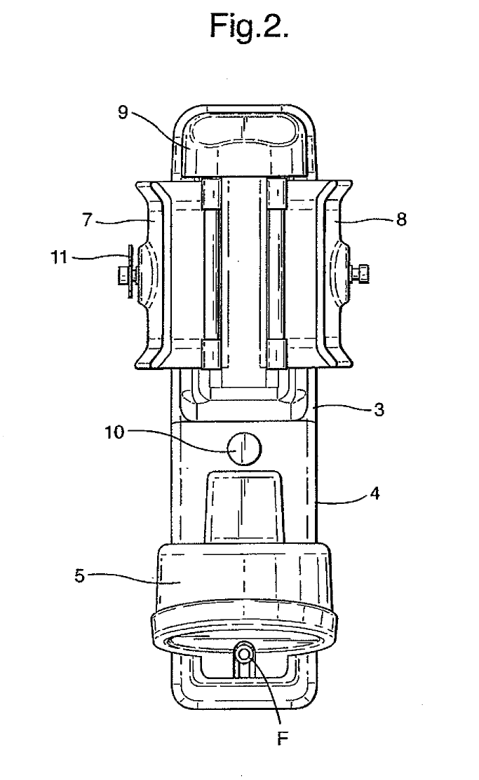

FIG. 2 is a front view of the holder of FIG. 1;

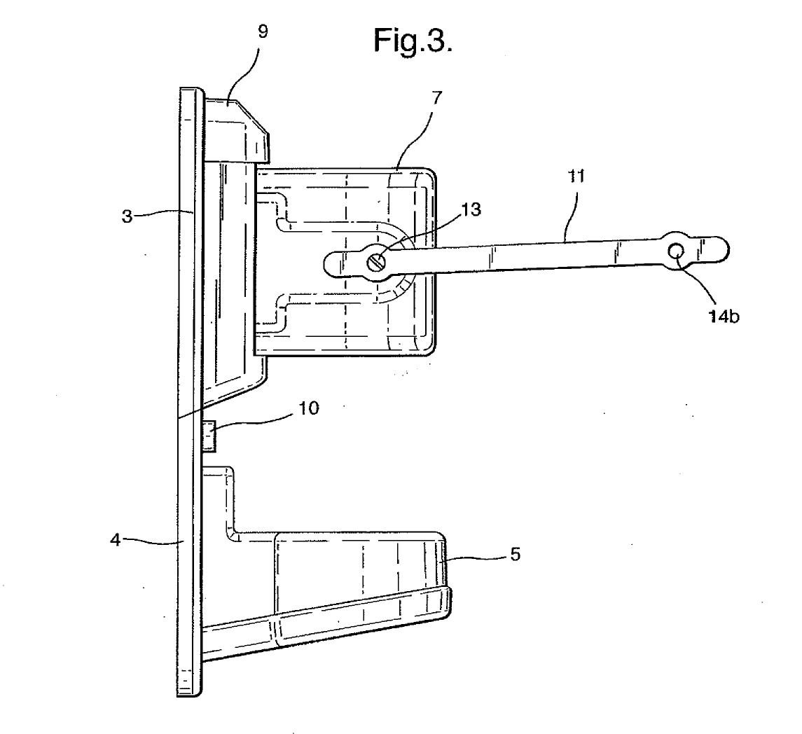

FIG. 3 is a side view of the holder according to FIG. 1;

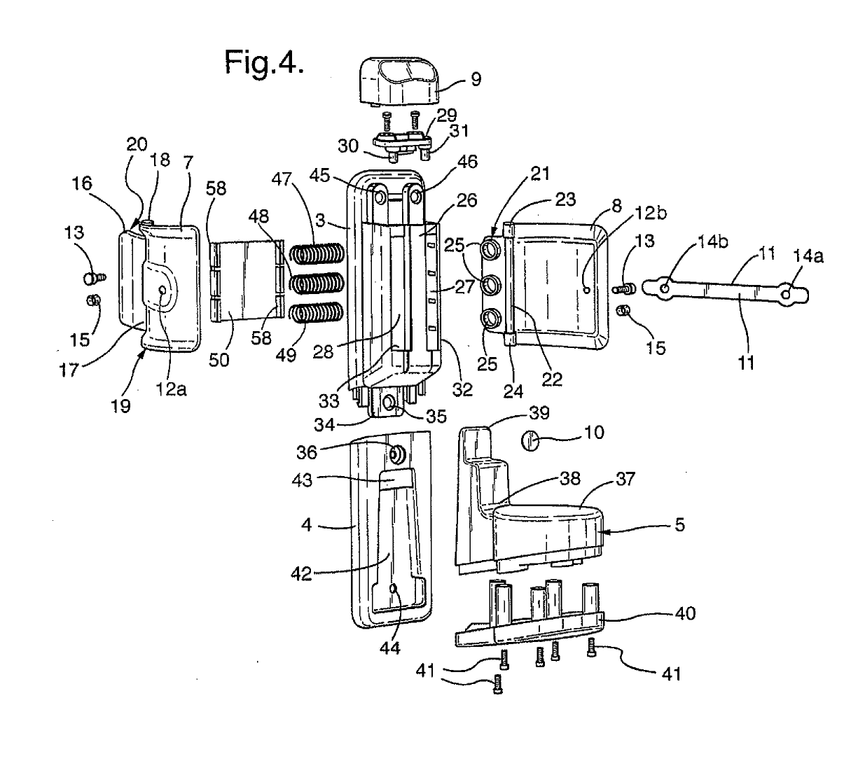

FIG. 4 is an exploded view of the holder of FIG. 1;

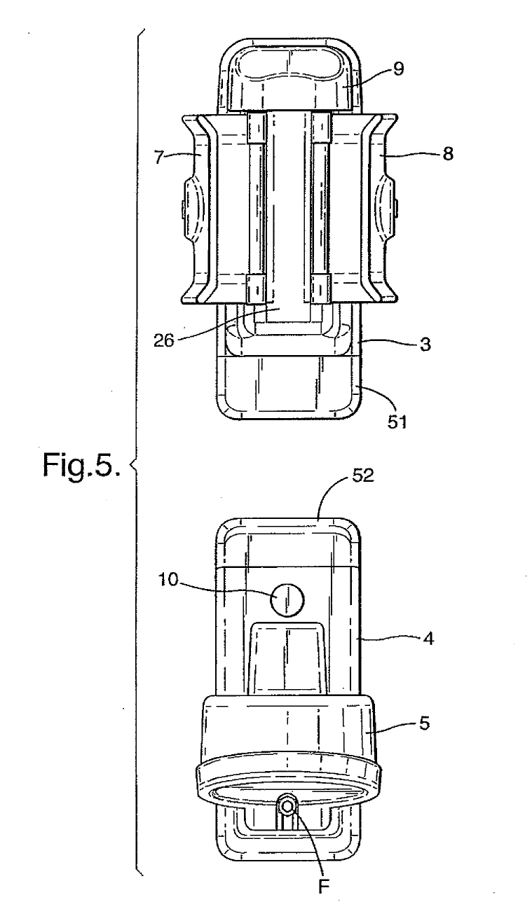

FIG. 5 is a front view of a second holder according to the invention having a base with two base portions mounted spaced apart from one another;

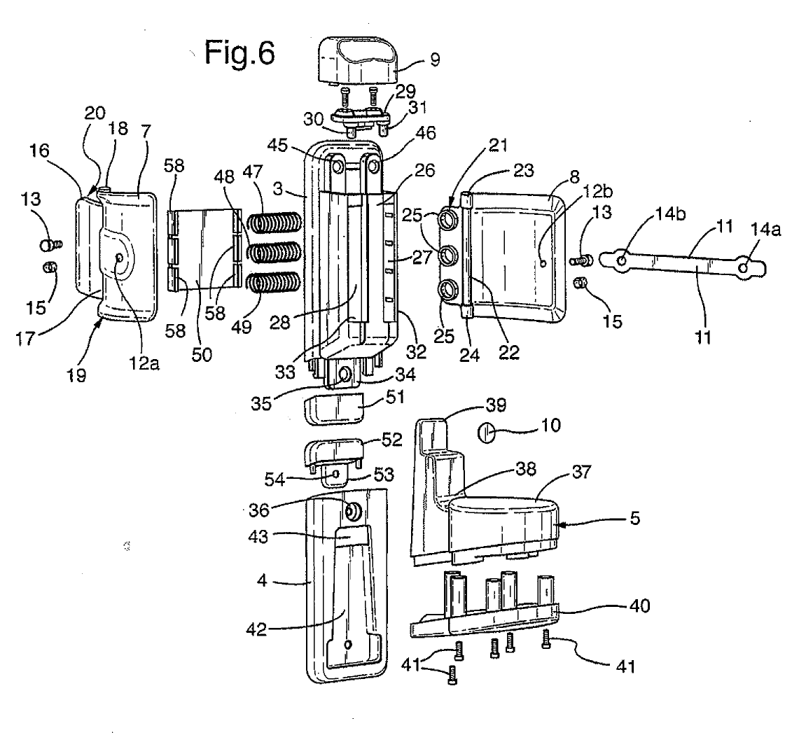

FIG. 6 is an exploded view of the holder of FIG. 5; and

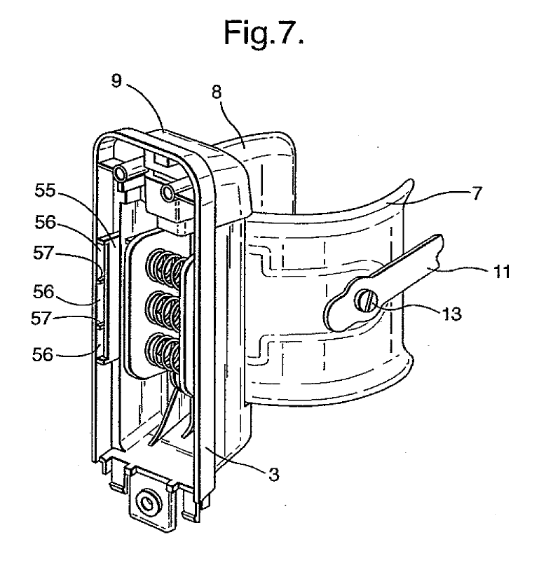

FIG. 7 is a perspective view, from behind, of a part of the holder of FIG. 5.

With reference to FIGS. 1 and 2, a holder 1 according to a first embodiment of the invention is suitable for restraining a cylinder of medical gas. The holder 1 has a base 2, which is made up of an upper part 3 and a lower part 4. The upper part 3 and lower part 4 are attached to one another, for example by interlocking elements or by snap fit elements. Extending from the lower part 4 of the base is a support member 5 defining a slightly concave recess 6 for receiving the cylinder base. The upper part 3 of the base is provided with a clamp device, including opposed jaw elements 7 and 8. The jaw elements are deflectable outwardly by means of resiliently deformable elements located behind upper part 3 of the base, as will be described in more detail below.

A snap fit cover 9 located at the upper end of the upper part 3 of the base serves to obscure from view in the mounted device fixing holder for affixing the base to a mounting surface. A stud 10 covers a fixing device, for example screw, which may additionally serve to lock together the upper part 3 and lower part 4 of the base. A further aperture is provided in the lower base part 4, beneath the support member 5, for receiving a fixing element F.

A flexible strap 11 is provided for additional security. Each of jaw elements 7 and 8 has an aperture 12a, 12b, respectively (see FIG. 4), for receiving a fixing element 13, for example a screw. Attachment apertures 14a, 14b each at opposed ends of the strap 11 (see FIG. 4) are, in use, positioned coaxially with a respective aperture 12 and a respective fixing element 13 may be passed through the coaxially arranged apertures. In the arrangement shown, each element 13 is screw-fixable into a permanently positioned threaded insert 15 which is permanently fixed, for example molded, into the jaw elements 7 and 8. Element 13 is screwed into position. The strap 11 is made of a flexible material such that each aperture 14a, 14b is stretchable for fitting over the respective permanently sited element 13 and the strap then stays in place.

If desired, the strap 11 can be omitted. When the strap arrangement is not required, element 15 on each jaw can be plugged with a small plastic plug ensuring a smooth surface on the outside of the jaws. It is, if desired, also possible for the jaws to be formed without the threaded inserts 15.

With reference to FIG. 4, jaw element 7 forms a portion of a jaw member further comprising a bearing element 16, which is separated from the jaw element 7 by a vertically extending pivot axis defined by vertically extending ridge 17. At the top of the vertically extending ridge is a widened portion 18 defining within it a cylindrical recess that is open at the top. A corresponding widened portion 19 (not visible in FIG. 4) defining a downwardly opening cylindrical recess is provided at the bottom of the ridge 17. The bearing element is provided with three annular projections 20 which, in the assembled holder, serve to locate the ends of three compression springs. Jaw element 8 is in corresponding manner associated with bearing element 21, vertically extending ridge 22, widened portions 23 and 24, and three annular projections 25.

The upper part 4 of the base has a forwardly projecting central web portion 26. To the right of the central column 26 is a vertical slot 27, which is large enough for the bearing element 21 to pass therethrough. At the top and bottom ends of the slot 27 are curved wall regions dimensioned and configured to receive, and allow pivoting of, the widened portions 23 and 24. The slot 27 is large enough to permit deflection of the jaw element 8 sufficient (with opposite deflection of similar magnitude of opposed jaw element 7) to permit withdrawal of the gas cylinder between the jaw elements. A further slot 28 is located on the opposed side of central web 26. The slot 28 is arranged in like manner to receive the jaw element 7, bearing element 16 and widened portions 18 and 19. A locating member 29, including two downwardly extending axles 30, 31 is fittable over the top of the central web 26 such that the axle 30 extends into the recess within upper widened portion 18 and the axle 31 extends into the recess within upper widened portion 23. In the assembled holder, the locating member is held in place by two additional vertical screws that descend through the locating member into the upper part 4. The cover 9 fits in over the locating member and fits in snap-fit manner onto the upper part 3. Lower axle members 32, 33 formed at the lower ends of slots 27, 28, respectively, extend upwardly into the widened portions 19, 24 respectively. The upper part 3 and lower part 4 of the base fit together and are located relative to one another by means of one or more tongues 34 and co-operating recesses in the upper edge of the lower part 4. An aperture 35 is provided in a central tongue 34, arranged to be coaxial with aperture 36 in the assembled holder.

The support member 5 has a rounded front portion 37 for receiving the base of a cylinder, a neck portion 38 and an upwardly extending tab portion 39. The support member 5 is formed as a hollow body, open at the bottom. The open bottom face is closed by a closure plate 40, providing additional support and strength. The closure plate 40 is attached to the hollow body by means of five fixing elements 41. The lower part 4 of the base has a recess 42 and a horizontally extending slot 43 at the upper extremity of the recess 42. The neck portion 38 and tab portion 39 are so dimensioned and configured that the tab portion can be inserted through the slot 43, such that the tab portion lies against the rear surface of lower part 4 above the slot 43, and the rear part of the support member 5 is snugly received within the recess 42. The support member is in that manner securely mounted and restrained from excessive movement in the assembled holder.

An aperture 44 is provided in the recess 42 and apertures 45 and 46 are provided near the upper edge of the upper part 3. The apertures 44, 45, 46 are for screw fixing elements for attaching the base to a wall or other mounting surface. In the assembled and mounted unit, the fixing element in aperture 44 is not obscured by the support member 5, the closure plate 40 being so configured that it surrounds the fixing aperture 44 allowing access to the aperture and whatever fixing is used through it. The fixing elements in apertures 45 and 46 are covered by cap 9, and the fixing element in aperture 36 is covered by the stud 10.

Behind the upper part 3, and extending, in the assembled holder, between the bearing elements 16 and 21 are three compression springs 47, 48, 49 as described in more detail below with reference to FIG. 7. A backplate 50 extends across the rear of the upper part 3 at the location of the compression springs. The backplate 50 snap-fits to mounting plates 55 braced against the inner surface of each of the lateral walls of the upper part 3, and serves to provide added strength and rigidity to upper part 3. With reference to the mounting plate shown on the left in FIG. 7, the mounting plate 55 is spaced from, and parallel to, the inner surface of the lateral wall. The void between the mounting plate 55 and the lateral wall is divided vertically into three substantially equal void portions 56 by two horizontally extending webs 57. Three return portions 58 on the backplate 50 are locatable within the three void portions 56. The mounting plate 55 on the opposite side is constructed in like manner.

In the embodiment of FIGS. 5 and 6, many of the parts of the holder are essentially the same as corresponding parts of the holder of FIGS. 1 to 4, and those parts are indicated by the reference numerals used for the corresponding parts in FIGS. 1 to 4. The holder of FIGS. 5 and 6 has two parts that are mounted separately on a support surface. The upper part 3 of the base, with the jaw elements 7, 8 and associated parts, is spaced from the lower part 4 of the base unit. The bottom of the part 3 is closed by a cap 51 and the top of the part 4 is closed by a cap 52. With reference to FIG. 6, the cap 51 is a snap fit onto the downwardly projecting tongues 34. The cap 52 includes a downwardly extending tongue 53, which has an aperture 54. The tongue 53 fits snugly into a recess in the rear of lower part 4 of the base unit such that the aperture 54 is coaxially located with respect to the aperture 36, permitting a fixing element to extend through the coaxial apertures for fastening of the lower part 4 to the wall or other support surface.

With reference to FIG. 7, in the assembled holder according to FIGS. 1 to 4 or FIGS. 5 and 6, the bearing elements 16 and 21 are located behind the front face of the upper part 3 of the base unit, and are so located that they are spaced from, and parallel to one another. The three compression springs 47, 48 and 49 extend between the bearing elements 16 and 21. The springs are axially parallel to one another, with a first end of each located within a respective ring 20 on bearing element 16 and a second end of each spring being located within a respective ring 25 on bearing element 21. The backplate 50 (not shown in FIG. 7), as mentioned previously, covers the springs in the assembled holder.

In use, a gas cylinder can be inserted between the jaw elements 7, 8, by deflecting one or, preferably, both of the jaw elements outwardly so as to increase the width of the opening between the two jaw elements to a spacing that is at least as great as the diameter of the cylinder. Outward deflection of one or both jaw elements is converted, by means of pivoting of the jaw members about their pivot axes, into an inward movement of the corresponding bearing element or elements, with resultant compression of the compression springs 47, 48 and 49. Once the cylinder has passed between the front ends of the jaw elements 7, 8, the jaw elements are urged back to their closed position, by virtue of the compression springs acting on the bearing elements 16, 21. The cylinder is then restrained in the desired position by means of the jaw elements 7, 8 and the support member 5, on which the cylinder base rests. When the cylinder is to be removed, for example for replacement of an empty cylinder by a full cylinder, the cylinder can be withdrawn between the jaw elements, thus once again urging the distal ends of the jaw elements apart sufficiently to allow the cylinder to pass therebetween, and consequently compressing the compression springs 47, 48 and 49 between the bearing elements 16 and 21. The jaw elements are urged back to their starting position after the cylinder has passed by means of the force applied by compression springs 47, 48 and 49 to the bearing elements 16 and 21.

If desired the holder may include more or fewer than three compression springs, for example two compression springs, or one. Other resiliently deformable elements may be used instead of compression springs if desired.

Although the foregoing invention has been described in detail by way of illustration and example for purposes of understanding, it will be obvious that changes and modifications may be practised within the scope of the appended claims.

1. A holder for a cylindrical article, the holder having a base, a support member extending from the base for receiving a base of the article, and, spaced from the support member, at least one clamp device extending from the base and arranged releasably to clamp the cylindrical article.

2. A holder according to claim 1, in which the clamp device comprises first and second opposed jaw elements.

3. A holder according to claim 2, in which the clamp device comprises a first jaw member comprising said first jaw element and a second jaw member comprising said second jaw element.

4. A holder according to claim 3, in which at least one of the first and second jaw members is displaceable from a starting position, in which the jaw elements of the opposed jaw members co-operate circumferentially partially to enclose a cylindrical article, to a position in which the jaw elements are spaced apart by a distance at least as great as the diameter of the cylindrical article.

5. A holder according to claim 4, in which the clamp device comprises at least one resiliently deformable element for urging said jaw members towards said starting position.

6. A holder according to claim 5, in which the at least one deformable element comprises at least one spring.

7. A holder according to claim 3, in which each jaw member has a bearing element and the clamp device further includes at least one spring that can act upon said bearing elements.

8. A holder according to claim 7, in which the jaw members are mounted pivotably on parallel pivot axes, such that the bearing elements of the jaw members are opposed to each other on one side of a plane containing said pivot axes and the jaw elements are opposed to each other on the opposite side of that plane.

9. A holder according to claim 7, in which the at least one spring comprises at least one compression spring.

10. A holder according to claim 7, in which at least two compression springs are located between the first and second bearing elements.

11. A holder according to claim 1, further comprising an additional fastening device for preventing release of the cylinder.

12. A holder according to claim 1, in which the base comprises one or more apertures permitting affixing of the base to a supporting structure.

13. A holder according to claim 1, in which the base comprises two parts.

14. A holder according to claim 13, in which the two parts are separately attachable to a support surface.

15. A holder according to claim 13, in which the two parts are attachable to one another to form a common base.
